(19) United States
(12) Patent Application Publication
(10) Pub. No.: US 2014/0124041 A1
(43) Pub. Date: May 8, 2014

(54) Device And Method For Plugging A Hole In A Membrane

(71) Applicant: Peter Nathan, Berkshire (GB)

(72) Inventor: Peter Nathan, Berkshire (GB)

(21) Appl. No.: 14/112,958

(22) PCT Filed: Apr. 19, 2012
(86) PCT No.: PCT/EP12/57221

§ 371 Date: Jan. 15, 2014

(30) Foreign Application Priority Data
Apr. 19, 2011 (GB) 1106633.9

(51) Int. Cl. B29C 73/24; B23P 6/04

(52) U.S. Cl. CPC B29C 73/24; B23P 6/04
USPC 137/15.01; 137/232

(57) ABSTRACT

A device is provided for plugging a hole in a membrane. The device comprises a cap including a chamber for storing compressed gas, an inflatable bladder connected to the cap and a first conduit via which fluid can escape from a distal side of the membrane whilst the device is inserted into the hole. The device further comprises a first control means for controlling the escaping fluid through the device, a second conduit via which a compressed gas can flow from the chamber into the inflatable bladder and a second control means for controlling the flow of compressed gas from the chamber into the bladder. The bladder is arranged to be inserted at least partially through the hole in the membrane in a non-inflated state and at least partially inflated after it has been inserted therein.

The invention relates to a device and method for plugging a hole in a membrane, in particular a membrane separating two fluids or two differentially pressured gasses.

### BACKGROUND

Membranes are used in many different practical situations for separating two fluids, including two gasses, two liquids or a liquid and a gas, at similar or differential pressures, from one another. For example membranes are used to make tanks for holding liquids, particularly temporary water tanks where a rubber membrane is used on a supporting framework, or simply under its own formed shape, to retain a liquid. Another example would be inflatable bodies such as life rafts that are filled with air or other gas under pressure such that the material from which the inflatable device is formed acts as a membrane between that gas under pressure and air at normal barometric pressure and/or water when the device is in use. For any membrane separating two fluids it is important to put safety mechanisms in place so that if the membrane tears or ruptures it can be mended as quickly and easily as possible to prevent the escape of the retained fluid. This becomes particularly important when the membrane in question is part of an inflatable boat or life raft, for which a hole in the membrane during use could lead to very serious and dangerous consequences.

Many known devices exist for mending holes in the membrane of a fluid retention container during use. However such devices have several drawbacks. Many require the user to use two hands in order to operate the device successfully. In practice the user may not be able to use both hands for fixing the hole during an emergency situation. For example, in the case of a boat, they may have to use one hand to hold on in a pitching sea. Tanks are often used to retain chemicals which are dangerous to the human skin and single handed application of the device with limited exposure to the escaping chemical is important. Another drawback with known devices is that they are often difficult to use if the hole in the membrane is below water, again as may be the case during an emergency situation on a life raft. The existing devices are at best temporary fixes that suffice until a permanent patching solution can be applied when the membrane is not in use.

An invention is set out in the claims.

According to an aspect there is provided a device for plugging a hole in a membrane. The device comprises a cap including a chamber for storing compressed gas, an inflatable bladder connected to said cap, a first conduit via which fluid can escape from a distal side of the membrane when the device is inserted into the hole and a first control means for controlling escape of said fluid through the device. The device further comprises a second conduit via which compressed gas can flow from the chamber into the inflatable bladder and a second control means for controlling the flow of compressed gas from the chamber into the bladder. For example, the first conduit may comprise a central conduit in the cap which will allow escaping fluid to continue escaping whilst the device is positioned, and the first control means may be arranged to shut off this central conduit once the device is in position. The bladder of the device is arranged to be inserted at least partially through the hole in the membrane in a non-inflated state and at least partially inflated after said insertion.

The device may further comprise a handle or actuator, for example a removable actuator. It may further comprise compressed gas or other fluid within the chamber.

The second control means for controlling the flow of compressed gas from the chamber into the bladder may include a retention valve. That retention valve may be closed when the bladder is in a non-inflated state, to prevent the flow of compressed gas along the second conduit. The second control means may further include a user actuatable trigger for triggering the release of compressed gas from the chamber into the bladder.

A guide tube may be provided for guiding insertion of the device into the hole in the membrane that is to be mended. The guide tube can also create an airflow passage, enabling air (or other gas or fluid) to flow between the bladder and the cap. The guide tube can thus prevent the material of the bladder from blocking fluid flow within the device. At least part of the bladder may be wrapped around such a guide tube during insertion of the device into the hole.

The device may comprise a throughflow valve which is actuatable to prevent fluid flow from a distal side of the membrane through the cap of the device. The first control means may be arranged to control actuation of that throughflow valve. The bladder may be a structured bladder. It may comprise a substantially central aperture which allows fluid flow from a distal side of the membrane through the cap of the device. It may comprise a substantially structured non-inflatable portion, preferably wherein that non-inflatable portion of the bladder is provided at a lower end of the bladder, distal to the cap of the device. Therefore, preferably the part of the bladder that is closest to the hole in the membrane that is being mended will be inflatable, thus being able to expand and plug or patch the hole. The lower part of the bladder is preferably non-inflatable to ensure that incoming compressed air from the cap causes the inflatable part of the bladder to inflate and expand laterally.

The device may include a suitable safety mechanism to prevent accidental use of the second control means for releasing compressed gas from the chamber into the bladder. It may also provide redundancy within the second control means wherein, if a first mechanism for releasing the compressed air from the chamber fails, a second mechanism is available to action release of the compressed air.

The device may comprise an adhesive on a surface of the bladder, proximal to the membrane (which is under repair) when the bladder is in an inflated state. The device may comprise one or more grippers provided on a surface of the cap, proximal to the membrane when the device is in use for repairing such a membrane.

The device may be used to plug or patch a hole in a membrane comprised in an inflatable body such as a life raft, a dinghy or an inflatable boat. The membrane may be comprised within a container such as a water tank, an emergency storage tank, a container for storing corrosive material or a container for storing medical substances.

According to another aspect there is provided a method of plugging a hole in a membrane using a device, said device comprising a cap including a chamber for storing compressed gas, an inflatable bladder connected to said cap, a first conduit via which fluid can escape from a distal side of the membrane when the device is inserted into the hole and a first control means for controlling escape of said fluid through the device. The device further comprises a second conduit via which compressed gas can flow from the chamber into the inflatable bladder, and a second control means for controlling the flow of compressed gas from the chamber into the bladder. The method comprises inserting part of the device, including at least part of the inflatable bladder, into the hole, wherein the bladder is in a non-inflated state during said insertion, and then actuating the control means in order to release compressed gas from the chamber into the bladder, so that at least part of the bladder becomes inflated.

According to an aspect there is provided a method of manufacturing a device substantially as described herein.

According to an aspect there is provided a method of operating a device substantially as described herein.

According to an aspect there is provided a device for plugging a hole in a membrane. The device includes an actuator at a first end and a guide at a second, distal end, with a housing for storing compressed gas or other fluid provided intermediate the actuator and the guide. When stored, the guide can include an inflatable member wrapped therearound. The actuator can include a hole or recess which is appropriately located, sized and shaped so that the guide at the distal end of one device, possibly including the inflatable member wrapped theraround, can be inserted into the recess in the actuator of a second, substantially identical device. A storage means is provided for storing such devices. The storage means can store multiple such devices, and in particular can stack them together compactly, with the guide at the distal end of a first device located in the recess in the actuator of a second device.

### FIGURES

Examples and embodiments will now be described with reference to the appended figures of which:

FIG. 1 is a cross section through a patching device with the bladder in a non-inflated state;

FIG. 2 shows the device of FIG. 1 before it is inserted into a ruptured membrane, with the safety pin removed;

FIG. 3 shows the device of FIG. 2 after insertion into the ruptured membrane;

FIG. 4 is a magnified view of the circled portion in FIG. 3;

FIG. 5 shows the device of FIG. 3 with the bladder in an inflated state and the actuator detached from the cap;

FIG. 6 shows a magnified view of the circled portion in FIG. 5;

FIG. 7 shows the device of FIG. 1 with the bladder in an inflated state;

FIG. 8 shows a packaging arrangement for 3 of the devices shown in FIG. 1;

FIG. 9 shows device of FIG. 1 when viewed from above; and

FIG. 10 shows a perspective view of the device of FIG. 1 the bladder in a non-inflated state.

### OVERVIEW

In overview a device is provided for plugging, patching or stopping a hole, rip or tear in a membrane that separates two fluids. In particular the device can be used for a membrane that separates a retained fluid from air at barometric pressure. The device can provide a permanent solution for plugging, patching or stopping such a hole.

The device (referred to herein as “a patching device”) comprises an actuator (or handle) for user grip during insertion of the device into the hole, a central conduit to allow the escaping fluid from a distal side of the membrane to continue escaping until the device is in position, a bladder which is at least partially expandable in order to cover the hole, and a cap which includes compressed gas for expanding the bladder once it is in situ. In use, the user can insert the patching device at least partially through a hole in the material or membrane of the body that is to be mended when the bladder is in its non-expanded state, so that the bladder is on the opposite side of the ruptured membrane to the cap and the actuator. The central conduit allows the device to be positioned without the resistance of the escaping fluid. Once the device is in place the user can then actuate a release mechanism, preferably located on the actuator of the device, in order to release compressed gas from the cap into the bladder in order to at least partially inflate the bladder and to close the central conduit. Therefore no more fluid is allowed to escape from a distal side of the membrane once the bladder has been inflated.

At least part of the bladder is connected to a part of the device that remains on the outer side of the ruptured membrane (i.e. on the same side as the outer parts of the device, including the cap) so that the expandable bladder material can only move away from such outer parts of the device to a limited extent. A non-expandable portion of the bladder may also be provided in order to limit the direction in, and extent to, which it can expand. As a result, expansion of the bladder creates pressure between the bladder and the cap part of the device, pushing them towards one another around the hole or rupture in the membrane, therefore acting as patch over that hole or rupture.

The device is scalable so can be manufactured and used to patch a range of hole sizes in a range of different materials in different practical situations. As mentioned above, it can be used to patch a hole in containers including hoses, water tanks including temporary emergency tanks, and containers which hold medical substances or corrosive or dangerous material which must be permanently plugged quickly and effectively should a hole be found therein. Additionally or alternatively, the device could be used to permanently patch holes in the material of a vessel such as an inflatable boat or life raft. Such vessels are usually made of plastic and/or rubber however the device could also be used to temporarily patch holes in more rigid membranes such as yacht hulls.

The device can be managed by the user with only one hand, firstly to insert the device into the hole and then to actuate a trigger to release compressed gas into the bladder. The device can work even when the hole in the membrane to be patched is already under water. It can include duplicate trigger mechanisms for health and safety purposes and can be manufactured to fully comply with safety regulations such as the ISO 9650 standard for life rafts. Thus a convenient, easy to use and safe device for permanently patching membranes is provided.

### DETAILED DESCRIPTION

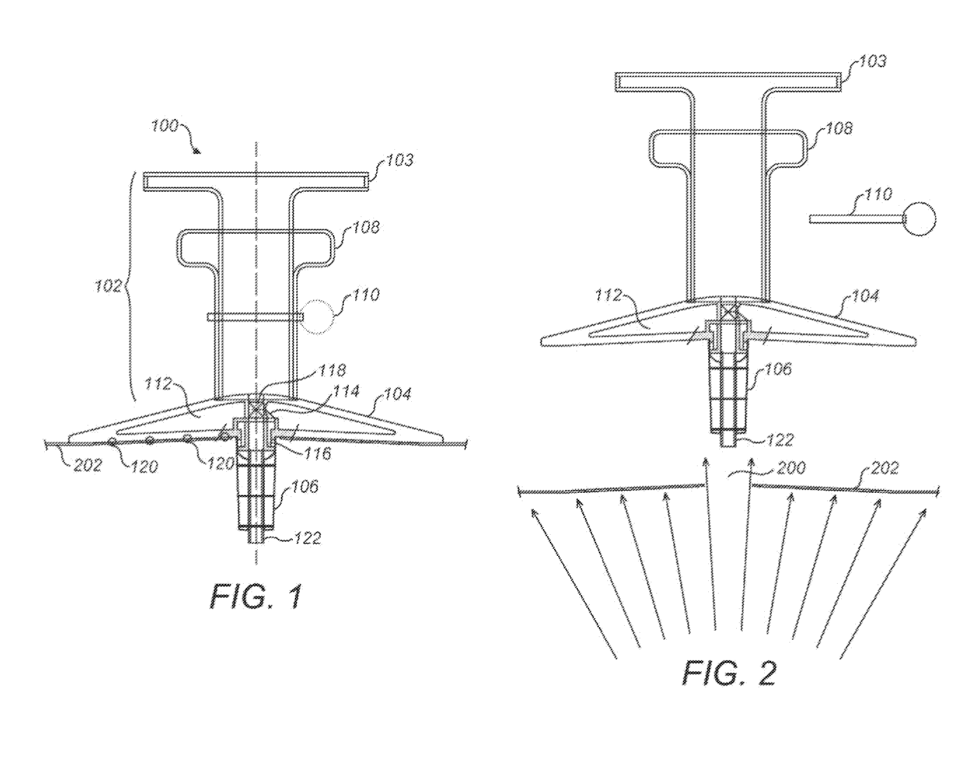

FIG. 1 shows a patch device 100. It includes an actuator (or handle) 102, a cap 104 and a bladder 106. In FIG. 1 the bladder is shown in its pre-deployed, i.e. non-expanded, state.

The actuator 102 is shown as including two components—a trigger 108 (discussed further below) and a substantially T-shaped actuator portion 103. Although any suitable shape may be used, a T-shape is convenient because the user can grip it easily, for example using the middle finger and forefinger to grip the stem of the T-shape and the thumb on the base of the actuator 102 to help with driving the device 100 into the hole or rupture that is to be patched. The T-shaped actuator portion 103 is preferably hollow and is aligned with a central conduit or hole running through the cap 104 of the device, as described in detail below. Preferably, at least one hole or vent is provided at the top of the T-shaped actuator portion 103, and/or at one or both sides of the T-shape so that fluid can escape therethrough during use of the device 100, as discussed in more detail below.

The actuator 102 comprises a trigger 108. In the device shown in FIG. 1 the trigger 108 is also substantially T-shaped in cross-section. It surrounds a lower portion of the T-shaped actuator portion 103 and is aligned along the same central axis so that, in use, the trigger 108 can be pulled upwards, sliding along the stem of the T-shaped actuator portion 103.

As described further below, the trigger 108 is used to activate expansion of the bladder 106. It is therefore important that it is used only when the device is in situ for patching a membrane. The trigger 108 therefore includes a safety mechanism such as the safety pin 110 shown in FIG. 1. The safety pin 110 is provided inserted through the actuator 102, running through the stems of both the T-shaped portion 103 and the trigger 108, to prevent relative movement of the trigger 108 and the T-shaped portion 103 until the safety pin 110 has been removed.

The actuator 102 may be formed of plastic or any other suitable material. It fits above the cap 104 as shown in FIG. 1. The actuator 102 is removably attached to the cap 104 so that the actuator 102 can be discarded once the device 100 has been inserted into a hole and the bladder 106 inflated to patch the hole. As will be described in more detail below, the cap 104 should be left in situ when the actuator 102 is removed in order to maintain the patching effect of the device 100 on the hole.

For example the actuator 102 can clip onto the cap 104 using a simple plastic clip. Alternatively the actuator 102 and cap 104 may attach to one another using any suitable snap fit, screw fit or push fit mechanism. The means of attachment between the actuator 102 and cap 104 should ensure that they do not detach from one another until after the device 100 has been activated for patching a hole.

The trigger 108 is arranged to activate one or more valves in the cap 104 in order to release compressed gas from the cap 104 into the bladder 106 as described in more detail below. It preferably also activates a valve which allows throughflow of fluid from one side of the membrane to another during insertion of the device 100.

The cap 104 is formed of plastic or any other suitable material. It includes a hollow gas storage chamber 112 within. In the device 100 shown in FIG. 1 the cap 104 is substantially conical in shape, with the narrow most portion of the cap 104 being at the top where it meets the actuator 102 and the broadest part of cap 104 being at its lower surface, close to the bladder 106, which will press against the membrane that is to be mended by the device 100 as discussed in more detail below. However it will be appreciated that any suitable shape of cap 104 may be used.

The gas storage chamber 112 within the cap 104 should be filled, preferably during manufacture, with a compressed gas such as compressed air. The compressed gas may be confined within a rubber tube, similar to a bicycle tube, within the gas storage chamber 112. For example the cap 104 can be manufactured inside a pressure chamber to help prevent leakage of gas from the gas storage chamber 112 after manufacture, before the device is used to patch a hole. Alternatively or additionally, a tube or other mechanism may be provided for topping up the compressed gas in the cap 104 after manufacture.

The compressed gas is retained within the gas storage chamber 112 by a retention valve 114. The retention valve 114 leads to a gas distribution chamber 116 located just below the cap 104. The gas distribution chamber 116 acts as a conduit, via which the compressed gas can travel from the cap 104 into the bladder 106 during use of the device 100. In the device 100 shown in FIG. 1 the gas distribution chamber 116 is comprised within a small cylinder located just below the cap 104. Preferably that cylinder is manufactured integral with the cap 104 but it could instead be attached thereto by any suitable mechanism, bearing in mind that the connection between the cap 104 and the gas distribution chamber 116 must withstand the force of compressed gas escaping from the gas storage chamber 112 within the cap 104, through the gas distribution chamber 116 and into the bladder 106. Therefore it must be a strong and reliable connection.

There is a central hole running through the cap 104 which includes a throughflow valve 118 (not visible in FIG. 1). Before use, when the safety pin 110 is still in place in the actuator 102, the throughflow valve 118 is open. As can be seen from FIG. 1 and again in more detail in FIG. 4 herein, the hole through the cap 104 (and therefore the through flow valve 118) is physically isolated from the gas storage chamber 112 within the cap 104, so that compressed gas from the gas chamber 112 does not escape through the open throughflow valve 118 before use of the device.

Grippers 120 can be provided on the underside of the cap 104, which is the surface that will come into contact with the membrane surrounding the hole or rupture that is to be patched by the device 100 during use. The grippers 120 help to keep the device 100 in place once it has been inserted through the hole, helping to prevent lateral slip and improving the reliability of the patching provided. The grippers 120 may include any suitable number of protrusions or projections and may be of the same material as the body of the cap 104 or may be of a different material, for example a material having a higher coefficient of friction. In the device shown in FIG. 1, the grippers 120 comprises a series of concentric circles made up of saw tooth gripping formations.

The bladder 106 is located below the cap 104. Also provided below the cap 104 is a guide tube 122 which is preferably a disposable guide tube. The guide tube 122 is aligned with the central axis through the cap 104 and the actuator 102 and extends substantially downwardly from the gas distribution chamber 116 at the base of the cap 104. The guide tube 122 is removably connected to the cap 104 in such a manner that the two will remain connected during insertion of the device 100 into a hole or rupture in a membrane which is to be patched but the guide tube 122 will disconnect from the cap 104 during or shortly after inflation of the bladder 106.

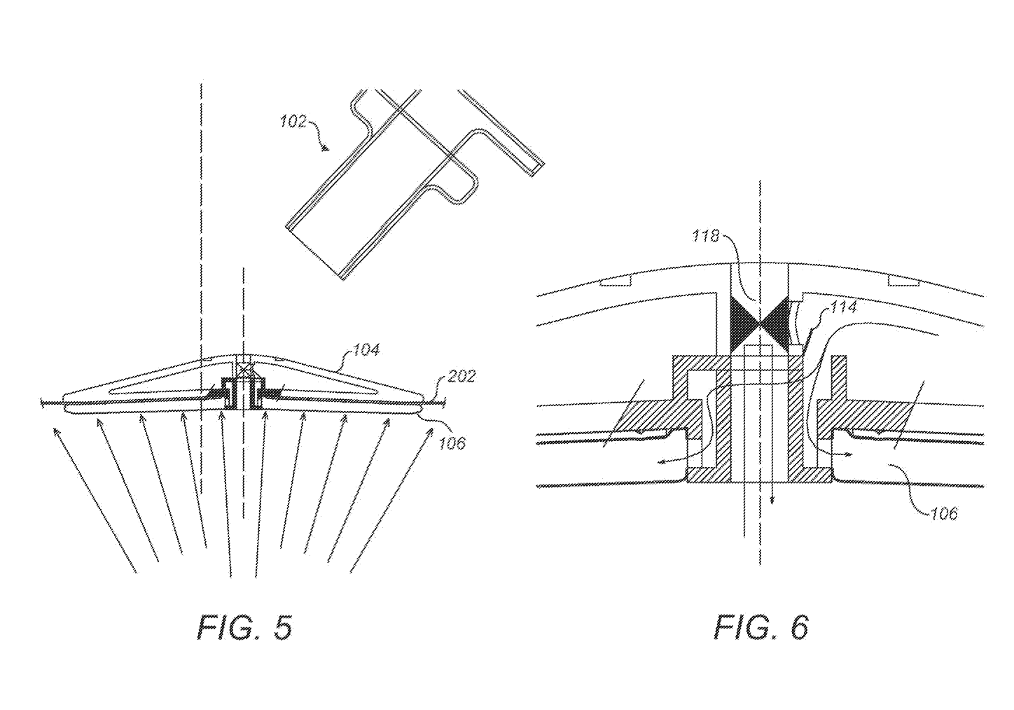

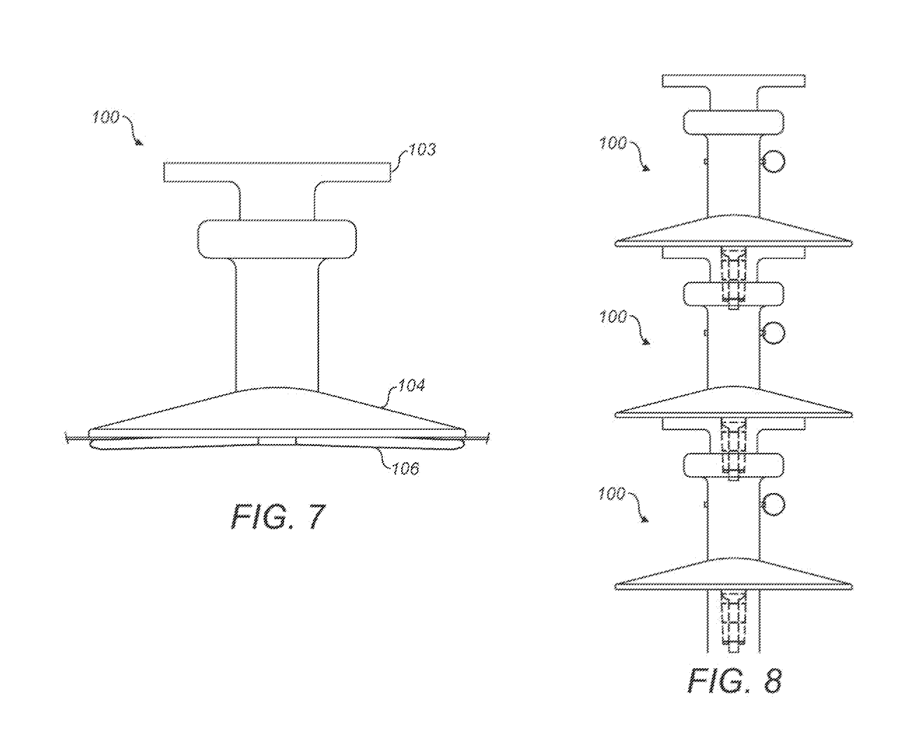

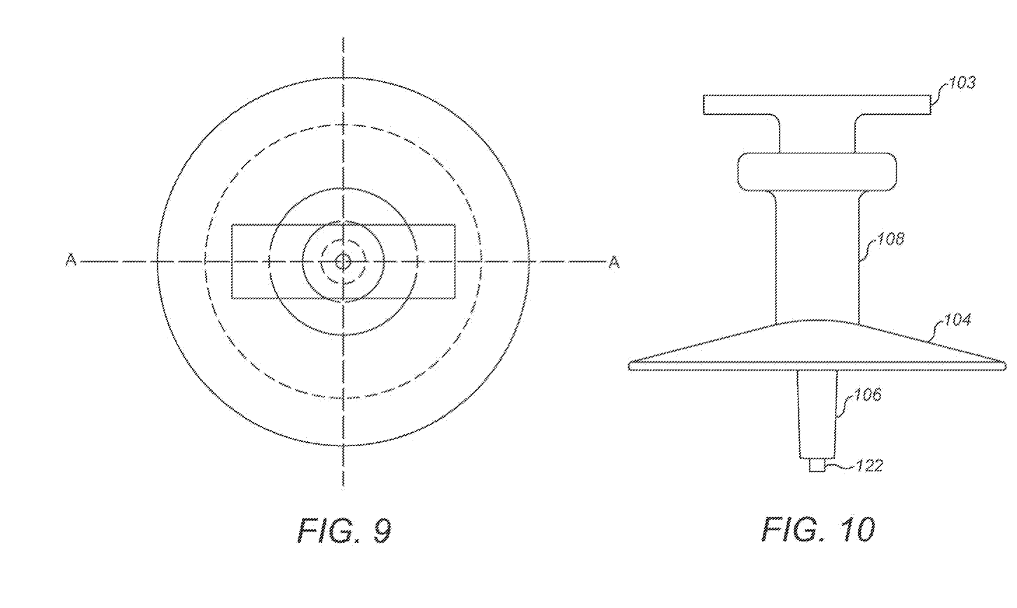

The bladder 106 is a sac or pouch which is at least partially inflatable. When in a non-inflated state, it can be provided in a substantially flat configuration. The bladder 106 is shown wrapped around the disposable guide tube 122 in FIGS. 1 to 3 herein. It can be seen in its expanded state in FIGS. 5 to 7 herein.

The bladder 106 is preferably an inflatable toroid or annulus (doughnut shaped), although other shapes are also possible. The bladder 106 should define a substantially central aperture which allows passage of fluid from the body into which the device 100 is to be inserted through to the substantially central holes in the cap 104 and actuator 102, along the central axis of the device 100 (shown in FIG. 1 and described above). This feature is highly useful because it allows fluid to escape from a distal side of the membrane, through the patching device 100, during insertion of the device 100 into the hole in the membrane that is to be repaired. Because this fluid is allowed to escape briefly during insertion of the device, the device will encounter minimal resistance and therefore it will be possible to insert it into the hole relatively quickly and easily. Once the device 100 has been inserted into the hole, control means within the device, such as the throughflow valve 118 discussed above, can ensure that no further fluid will escape from the distal side of the membrane. Therefore the aperture in the bladder provides a benefit of making insertion of the device into the hole easier, thereby reducing user effort and also reducing the amount of fluid that will escape through the hole from a distal side of the membrane, by enabling the hole to be plugged or patched quickly. The bladder 106 is preferably structured, having distinct upper and lower portions. An upper portion of the bladder 106, closest to the cap 104, is comprised of an expandable material. Preferably it is comprised of a very expandable material such as synthetic rubber. A lower portion of the bladder 106, distal to the cap 104, is comprised of a non-expandable material for example a rubber impregnated canvas. As a result, when compressed gas is released from the cap 104 into the bladder 106, that compressed gas can only serve to expand the upper portion of the bladder 106, nearest the cap 104. This is discussed further below. The upper and lower portions of the bladder connect together in any suitable manner, wherein that connection is strong enough to withstand the force of the compressed air entering the bladder and expanding the upper portion, and will remain steadfast when the device is left in situ after insertion.

The bladder 106 is securely connected to the cap 104. It should be connected to the cap 104 in the vicinity of its substantially central aperture, which is aligned with the central axis running through the actuator 102, cap 104 and gas distribution chamber 116 of the device 100. For example, the bladder material surrounding that central aperture can be bonded to the cylinder below the cap 104, in which the gas distribution chamber 116 is comprised. The connection between the bladder 106 and the cap 104 should be resilient and strong enough to withstand the force of the compressed gas flowing out of the gas storage chamber 112 (within the cap 104) into the bladder 106 in order to expand the upper portion of the bladder 106.

As mentioned above, before use the bladder 106 is stored compactly, preferably being wrapped as tightly as possible around the disposable guide tube 122. The bladder 106 can be held in place around the guide tube 122 with rubber bands which will break when the bladder 106 expands or by any other means that will allow rapid expansion of the upper portion of the bladder 106 during use. The area of bladder material that will form its upper surface in its expanded state, and will therefore come into contact with the membrane around the hole that is being plugged, and possibly also with part of the lower surface of the cap 104, can include an adhesive that would be released on expansion of the bladder 106. For example the upper portion of the bladder 106 can be covered with alternate strips of two components of a rapidly curing adhesive, each strip contained in a thin sheaf for example made of plastic. When the upper portion of the bladder 106 expands, the thin sheaths would rupture, releasing the two components which would mix and stick the device 100 to the membrane surrounding the hole, thereby improving the patch provided.

### Using the Device

Use of the device 100 can be further understood with respect to FIGS. 2 to 6 herein. Such use will be described herein with respect to a hole 200 in the membrane 202 of an inflatable body having compressed air therein. Therefore air is shown escaping from the hole 200 in the figures. However the same principles of use can be applied regardless of what type of membrane is being plugged and regardless of the type of fluid, be it gas or liquid, which is present on either side of the membrane.

Once a hole 200 or perforation in a membrane 202 has been discovered, the user will want to repair the membrane 202 by plugging or patching the hole 200 as quickly as possible. To do so he or she should grasp the device 100 by the T-shaped portion 103 of the actuator 102. The safety pin 110 can be extracted at this point or after the device 100 has been inserted into the hole 200. As shown in FIG. 2, the bladder 106 remains in the undeployed, i.e. non-expanded, state, wrapped around the guide tube 122, during insertion of the patching device 100 into the hole 200.

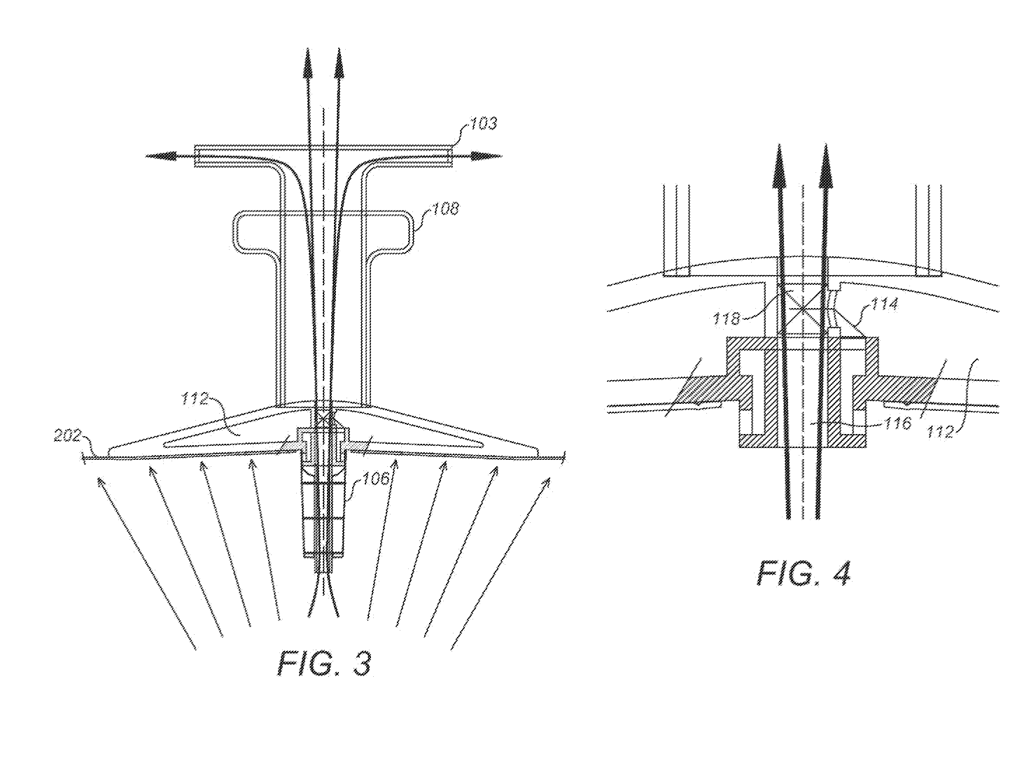

As can be seen from FIG. 3, the device 100 should be inserted into the hole 200 as far as possible, so that the guide tube 122 and bladder 106 are located on the distal side of the ruptured membrane 202, inside the inflatable body which has been ruptured, and the cap 104 and actuator 102 parts of the device 100 remain on the proximal side of the membrane, outside of the vessel. Insertion of the device 100 into the hole will displace some compressed air from within the inflatable body. The substantially central aperture defined within the bladder works in conjunction with the hollow core of the guide tube 122 and throughflow valve 118 within the cap 104 to allow the displaced air to flow through the device 100, flowing through one or more holes or vents at the top of the actuator 102 to allow the escaping air to pass through the device 100. As a result, the user will encounter little resistance in placing the device 100 as far into the hole 200 as possible.

Once the device 100 has been inserted as shown in FIG. 3, it must be activated to prevent further escape of fluid from the body under repair. In order to do this, the user activates the trigger 108. As a result, both the throughflow valve 118 and the retention valve 114 within the cap 104 are actuated. In the device 100 shown in the figures herein, activation of the trigger 108 comprises pulling the trigger 108 upwards along the stem of the T-shaped portion 103 of the actuator 102. Optionally, activation of the trigger 108 could require twisting the trigger portion. Or it could be actuated in another way such as by pushing, sliding or even breaking a portion of the trigger 108, dependent on its physical configuration and the manner in which it is connected to the rest of the actuator 102 and the cap 104.

Regardless of the physical action required to activate the trigger 108, said activation serves to open the retention valve 114 within the cap 104. For example the retention valve 114 may be a pivotable flap made of metal or another durable material wherein activation of the trigger 108 pivots the flap away from an opening in the gas storage chamber 112, and therefore allows the compressed gas from within the gas storage chamber 112 to flow through into the bladder 106 and expand the upper portion of the bladder 106 quickly. As the bladder 106 expands, it will be constrained by the inability of the material of its lower portion to stretch whereas, in contrast, the upper portion of the bladder 106 will be able to stretch rapidly. As a result, the expanded bladder will push upwards against the lower surface of the cap 104, trapping the perforated membrane 202 between the bladder 106 and the cap 104.

As another example, the gas storage chamber 112 may comprise a thin wall, which would act as a diaphragm supported by the actuator 102. As the actuator 102 moves up during operation of the device 100, the diaphragm would no longer be supported and would flex, thus triggering the retention valve 114.

As an alternative, the gas storage chamber 112 within the cap 104 may comprise a pouch or other formation that can be ruptured relatively easily. The retention valve may comprise a valve having a spike on one end wherein activation of the trigger 108 causes the valve to move and the spike to penetrate and burst the gas storage chamber 112, thus releasing the compressed air towards the bladder 106. The pressure of the compressed air being forced out of the gas storage chamber 112 can cause the spiked valve to move back in an opposite direction, hence sealing the cap 104 and preventing fluid flow therethrough. A spiked valve may be provided on either side of the central axis of the gas storage chamber 112 in order to rupture the chamber at two places to facilitate release of compressed air into either side of the bladder 106. Redundancy may be provided, for example two spiked valves may be provided on either side of the central axis, so that there is a spare spiked valve on each side in case the first one fails to rupture the gas storage chamber 112.

As mentioned above, optionally there may be an adhesive provided on an upper surface of the bladder 106. In an embodiment wherein two-part adhesive is provided in separate parts within thin plastic sheaths on the bladder surface, expansion of the bladder 106 will rupture the sheaths and cause adhesive to randomly spread in all directions. At least some of the two parts of the adhesive will mix and as a result the bladder 106 will bond to the underside of the membrane 202.

If the device includes grippers 120 on the underside of the cap 104, the membrane 202 will be forced against grippers 120 and will be mechanically held in place by them.

As the bladder 106 expands, the guide tube 122 around which the bladder 106 was wrapped will preferably disconnect from the device 100 and fall away inside the inflatable body or vessel. Preferably the guide tube 122 is formed of cardboard or another unreactive material and has no sharp edges so that it will not cause any damage to the inside of the inflatable body.

As well as releasing the retention valve 114, activation of the trigger 108 causes closure of the throughflow valve 118 within the cap 104, therefore preventing any further escape of fluid through the hole in the membrane 202. Therefore the throughflow valve 118 will not allow escape of the compressed gas out of the device 100. Optionally, the retention valve 114 and throughflow valve 118 could be triggered separately from one another but the user is likely to prefer to use a single activation for both valves to save time and effort, particularly in an emergency situation.

The throughflow valve 118 may be of any suitable type. It must be able to withstand the pressure exerted on it by compressed air within a life raft or other inflatable member and to remain closed to prevent escape of that compressed gas. For example the through flow valve 118 could be similar to a valve used in standard car tyres with a central pin which is suppressed in its standby mode, before expansion of the bladder 106, wherein that pin is released to seal the throughflow valve 118 when the trigger 108 of the present device 100 is activated. Once the throughflow valve 118 has been shut, no more air or other fluid should escape through the hole 200.

By way of example, the actuator 102 of the device 100 can include a prong or spike protruding down the central axis of the device 100, wherein that prong or spike acts to hold down a spindle or other formation which keeps the through flow valve 118 in the open position. As the actuator 102 disengages, the spike can releases the valve pin which shuts the through flow valve 118.

As can be seen in FIG. 5 herein, when the device 100 is used to patch a membrane retaining a fluid or gas at a different pressure to the air or other gas outside the membrane then the pressure of the retained fluid or gas within the membrane will force the bladder 106 towards the ruptured membrane 202, therefore further improving the seal provided.

Once the bladder 106 has been expanded and the hole 200 has been patched, the actuator 102 can be detached from the rest of the device 100. Detachment of the actuator 102 can be forced by the continued pressure on the trigger 108, exerted by the compressed gas inside the inflated bladder 106 pushing upwards. Alternatively or additionally, the actuator 102 may be detached from the cap 104 by the user by releasing the attachment mechanism therebetween for example by twisting, pushing or unclipping said mechanism. For example there may be a plurality of clips securing the actuator 102 to the remainder of the device 100. In use, if the trigger 108 is pulled upwards along the stem of the T-shaped portion 103 of the actuator 102, the clips will disengage, thereby releasing the actuator 102. The actuator 102 can be discarded.

As shown in FIG. 8 herein, the device 100 can be packaged and sold in sets of three. Preferably there is a hole in the top of the actuator 102, extending along the central axis of the device 100. The hole should preferably be sized to accommodate the width of the bladder 106 wrapped around the guide tube 122 at the bottom end of an identical device 100. As a result, the wrapped bladder 106 and guide tube 122 at the end of one device 100 can be inserted into the hole at the top of the actuator 102 of a subsequent device 100 in order to package them compactly. This method of packaging also protects the bladder 106 and guide tube 122 and prevents damage thereto during storage and shipping of the device 100. Although the device 100 is highly reliable, it should preferably be sold in sets of at least two so that the user has a fallback if the device 100 malfunctions in an emergency situation.

Whist the device has been referred to as a patching device herein, it can be ascribed a different name. For example it may be called a “plug” or a “jimmel”.

Whilst the device and its operation have been described with respect to the particular arrangements shown in the figures, some variations in the physical shape and size of the device components—and in the manner in which they connect and/or interact with one another—can be made.

The device is highly useful in practical situations. Before the device is required for use, the gas chamber within the cap can already have the compressed gas or other fluid stored therein that could be used to expand the bladder and therefore seal a hole into which the device is inserted when it becomes needed. The device can therefore operate in isolation, without requiring any additional components in order to work. It does not require complicated or lengthy user instructions to be provided—the method of use can be described quickly and clearly, and is straight forward to understand. Therefore the device does not require a skilled user in order to be used correctly.

The throughflow valve allows a limited amounted of compressed gas or other fluid from within the vessel or other body that is being patched to escape, therefore allowing ease and speed of insertion of the patch device into the hole. But that throughflow valve can close quickly and easily, upon activation of a simple mechanical trigger, in order to prevent any further escape of the contained fluid. On the other hand, the retention valve acts to ensure that the compressed gas does not escape from the gas storage chamber before the device is activated but can be easily and quickly triggered to open and release the compressed gas into the bladder, which expands to trap the ruptured membrane between the bladder and the cap.

Preferably the trigger mechanism will include a duplicated system, one on either side of the central axis shown in FIG. 1 herein. Therefore there would be a mechanical linkage from the trigger to the throughflow valve and the retention valve on each side of the actuator. This provides redundancy so that if one linkage fails the other should still work, to ensure that activation of the trigger actuates the two valves as described in detail above. This back up is particularly important if the patching device is to be used on inflatable such as life rafts or a container holding corrosive or otherwise dangerous liquid, for which risk of malfunction must be reduced as much as possible.

The device is a consumable component and may have a limited shelf life which could be indicated on the packaging when the device is sold. As discussed above, the bladder may be at least partially composed of rubber. The rubber material may deteriorate over time such that it would need to be disposed of and replaced if not used within a time limit. It may be possible to remove the bladder and replace it without replacing the remainder of the device or the entire device may have a shelf life after which it must be replaced in its entirety.

As mentioned above, means can be provided for topping up the compressed gas within the gas storage chamber of the cap. For example an external valve may be provided on the surface of the cap to allow this topping up. Alternatively or additionally, the device may include a pressure indicator such as a green/red indicator to provide a visual sign as to the pressure level of the gas within the cap.

Operation of the device requires only one user and can be managed one-handed by that user. This makes it very convenient and safe to use particularly in emergency situations. As mentioned above, the device can be manufactured to fully comply with ISO 9650 standard for life rafts and with other safety standards.

The device may be manufactured to any desired scale. According to an embodiment, the device is presented as a 100 mm diameter circular plug. The principles described herein can be expanded or reduced to provide larger or smaller plugs, and different shapes of plug can also be provided.

Because the bladder attaches to the cap of the device only in the vicinity of the substantially central aperture defined by the bladder, the surfaces of the bladder and the cap can be spaced apart from one another, either side of the ruptured membrane, once the bladder has been inflated. The upward pressure of the compressed gas in the inflated bladder will be sufficient to press up against the cap and form a seal over the hole or rupture in the membrane, regardless of the thickness of the surrounding membrane and the separation that it may cause between the bladder and the cap. Therefore the device can be used to plug holes in membranes of a range of different thickness. If the device is to be used with a relatively thick membrane, additional sealing means may be provided around the substantially central aperture between the bladder and the cap to ensure that no fluid can escape there-through during use.

The safety pin and trigger mechanism as described herein could be replaced by any suitable alternative. Additional features may also be incorporated into the device to prevent accidental activation. For example the cap could be hinged when the device is stored before use with a requirement that the cap must be flattened about its hinge before the user can pull the trigger to activate the bladder.

Therefore a highly and practical device for plugging or patching a ruptured membrane is provided. The device is simple, fast and easy for a user to manage, even in emergency situations, and enables them to stop a hole or rupture in a membrane separating two fluids safely and reliably. The device provides a substantially permanent solution rather than a temporary fix. However, it could be removable in order to re-open the ruptured membrane, if desired. The fact that the device can provide a permanent solution means it can be used for patching holes in devices such as inflatable vessels and water tanks which are needed for continuous and/or repeated use, without having to be replaced at least in the medium term. Therefore the vessel or tank does not have to be taken out of use in order for the ruptured membrane to be repaired. This type of efficient, reliable and substantially permanent solution is not provided by other any known devices.

The inflatable part of the device has been referred to herein as a “bladder” however any other suitable term could be used to describe it. As will be appreciated from the detailed description hereabove, the inflatable part of the device should be compact for insertion through the hole to a distal side of the membrane and then should be capable of being inflated quickly by the released compressed gas. Preferably the inflatable part of the device is structured, with a non-inflatable section or other means to prevent too much inflation in the direction along the central axis of the device, and to instead encourage lateral inflation, substantially perpendicular to that axis, to encourage complete and reliable coverage of the hole that is under repair.

The part of the device which includes a gas storage chamber for storing compressed gas has been referred to herein as a “cap” but any other suitable term may be used to describe it. As described in detail hereabove, this portion of the device should ideally be removably attached to the actuator, so that the actuator can be removed after the device has been used whilst leaving the cap portion in place to cover the outer side of the hole in the membrane under repair. The cap portion should be reliably fixed to the bladder so that a connection is maintained therebetween after insertion of the bladder, so that the ruptured membrane is held tightly and the hole remains sealed.

The terms “inner”, “outer”, “above”, “below”, “upper”, “lower”, “bottom”, “top”, “base”, “downwardly”, “underside”, “central”, “inside” and “upwards” have been used herein. Their use is for the purpose of describing the embodiments shown in the appended figures only and is not intended to be limiting.

1. A device for plugging a hole in a membrane, the device comprising:
a cap including a chamber for storing compressed gas;
an inflatable bladder connected to said cap;
a first conduit via which fluid can escape from a distal side of the membrane whilst the device is inserted into the hole;
a first control means for controlling the escaping fluid through the device;
a second conduit via which compressed gas can flow from the chamber into the inflatable bladder; and
a second control means for controlling the flow of compressed gas from the chamber into the bladder,
wherein the bladder is arranged to be inserted at least partially through the hole in the membrane in a non-inflated state and at least partially inflated after said insertion.

2. A device as claimed in claim 1 further comprising an actuator.

3. A device as claimed in claim 1 further comprising compressed gas within the chamber.

4. A device as claimed in claim 1 wherein the second control means for controlling the flow of compressed gas from the chamber into the bladder includes a retention valve.

5. A device as claimed in claim 4 wherein said retention valve is closed when the bladder is in a non-inflated state, to prevent flow of compressed gas along the second conduit.

6. A device as claimed in claim 1 wherein the second control means for controlling the flow of compressed gas from the chamber into the bladder includes a user-actuatable trigger.

7. A device as claimed in claim 1 further including a guide tube for guiding insertion of the device into the hole.

8. A device as claimed in claim 8 wherein at least a part of the bladder is wrapped around the guide tube during insertion of the device into the hole.

9. A device as claimed in claim 1 wherein the bladder defines a substantially central aperture, wherein said substantially central aperture enables fluid flow from a distal side of the membrane through the cap of the device.

10. A device as claimed in claim 9 further comprising a throughflow valve, wherein said valve is actuatable to prevent fluid flow from a distal side of the membrane through the cap of the device.

11. A device as claimed in claim 10 wherein the first control means is arranged to control actuation of said throughflow valve.

12. A device as claimed in claim 10 wherein said throughflow valve is open when the bladder is in a non-inflated state.

13. A device as claimed in claim 1 wherein the bladder comprises a substantially structured non-inflatable portion.

14. A device as claimed in claim 11 wherein said substantially non-inflatable portion of the bladder is provided at a lower end of the bladder, distal to the cap of the device.

15. A device as claimed in claim 1 further comprising a safety mechanism to prevent accidental use of the second control means for controlling the flow of compressed gas from the chamber into the bladder.

16. A device as claimed in claim 1 further comprising an adhesive on a surface of the bladder, proximal to the membrane when the bladder is in an inflated state.

17. A device as claimed in claim 16 further comprising one or more grippers provided on a surface of the cap of the device.

18. A device as claimed in claim 1 wherein the membrane is comprised in an inflatable body.

19. A device as claimed in claim 18 wherein the inflatable body is any of: a life raft, a dinghy, or an inflatable boat.

20. A device as claimed in claim 1 wherein the membrane is comprised in a container.

21. A device as claimed in claim 20 wherein the container is any of: a water tank, an emergency storage tank, a container for storing corrosive material, or a container for storing medical substances.

22. A kit comprising a plurality of devices as claimed in claim 1.

23. A method of manufacturing a device as claimed in claim 1.

24. A method of plugging a hole in a membrane using a device, said device comprising
a cap including a chamber for storing compressed gas, an inflatable bladder connected to said cap, a first conduit via which fluid can escape from a distal side of the membrane whilst the device is inserted into the hole;
a first control means for controlling the escaping fluid through the device;
a second conduit via which compressed gas can flow from the chamber into the inflatable bladder; and
a second control means for controlling the flow of compressed gas from the chamber into the bladder; the method comprising:
inserting part of the device, including at least part of the inflatable bladder, into the hole, wherein the bladder is in a non-inflated state during said insertion; and
actuating the control means in order to release compressed gas from the chamber into the bladder, so that at least part of the bladder becomes inflated.

25. A method as claimed in claim 24 further comprising the step of, during insertion of the device into the hole, allowing flow of fluid from a distal side of the membrane through the cap of the device and out.

26. A method as claimed in claim 24 further comprising, after insertion of the device into the hole, actuating the control means to prevent further flow of fluid from a distal side of the membrane through the cap of the device.

27. (canceled)
